(19) United States
(12) Patent Application Publication
(10) Pub. No.: US 2026/0331371 A1
(43) Pub. Date: Oct. 22, 2026

(54) MULTILAYER ELECTRONIC COMPONENT

(71) Applicant: SAMSUNG ELECTRO-MECHANICS CO., LTD., Suwon-si (KR)

(72) Inventors: Won Su SON, Suwon-si (KR); Seung Hun BAEK, Suwon-si (KR); Yoo Jeong PARK, Suwon-si (KR); In Kyung JUNG, Suwon-si (KR)

(73) Assignee: SAMSUNG ELECTRO-MECHANICS CO., LTD., Suwon-si (KR)

(21) Appl. No.: 19/648,675

(22) Filed: Apr. 15, 2026

(30) Foreign Application Priority Data
Apr. 18, 2025 (KR) 10-2025-0051042
Jun. 12, 2025 (KR) 10-2025-0076922

(51) Int. Cl. H01G 4/232; H01G 4/012; H01G 4/12; H01G 4/224; H01G 4/30

(52) U.S. Cl. CPC H01G 4/232; H01G 4/012; H01G 4/12; H01G 4/224; H01G 4/30

(57) ABSTRACT

A multilayer electronic component includes a body having a capacitance formation portion in which dielectric layers and first and second internal electrodes are alternately stacked in a thickness direction, upper and lower cover portions disposed on opposite sides of the capacitance formation portion, and first to sixth surfaces defining thickness, length, and width directions. First and second external electrodes are disposed on opposing side surfaces of the body. Each of the upper and lower cover portions includes multiple groove portions formed on an external surface facing the thickness direction and extending along the length direction of the body, thereby defining a structural configuration of the cover portions relative to the capacitance formation portion.

### CROSS-REFERENCE TO RELATED APPLICATIONS

This application claims benefit of priority to Korean Patent Application No. 10-2025-0051042 filed on Apr. 18, 2025 and Korean Patent Application No. 10-2025-0076922 filed on Jun. 12, 2025 in the Korean Intellectual Property Office, the disclosure of which are incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices, including a liquid crystal display LCD and a plasma display panel PDP, computers, smartphones and mobile phones, and serves to charge or discharge electricity therein or therefrom.

Multilayer ceramic capacitors may be used as components in various electronic devices due to their advantages of being small in size, ensuring high capacitance, and being easily mounted, as various electronic devices such as computers and mobile devices become smaller and have higher output, the demand for miniaturization and high capacitance multilayer ceramic capacitors is increasing.

A body of the MLCC may include a capacitance formation portion having dielectric layers and internal electrodes alternately disposed therein, and a cover portion disposed on upper and lower portions of the capacitance formation portion. During the sintering process, the cover portion, which only contains the dielectric, exhibits isotropic shrinkage behavior, but as the capacitance formation portion exhibits anisotropic shrinkage behavior, a shrinkage mismatching phenomenon may occur between the cover portion and the capacitance formation portion. Accordingly, there is a risk that cracking may occur in the body, reducing reliability.

### DISCLOSURE OF INVENTION

### Technical Problem

An aspect of the present disclosure is to provide a multilayer electronic component having improved reliability.

An aspect of the present disclosure is to provide the multilayer electronic component having a suppressed crack occurrence.

An aspect of the present disclosure is to provide the multilayer electronic component having a structure capable of suppressing a shrinkage mismatching phenomenon between a cover portion and a capacitance formation portion during sintering.

However, problems to be solved by the present disclosure are not limited to the above, and will be more easily understood in the process of describing specific embodiments of the present disclosure.

### Solution to Problem

A multilayer electronic component according to an example embodiment of the present disclosure may include: a body including a capacitance formation portion comprising a dielectric layer and first and second internal electrodes alternately disposed in a thickness direction with the dielectric layer interposed therebetween, upper and lower cover portions disposed respectively on the upper portion and lower portion of the capacitance formation portion in the thickness direction, a first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and a first and second external electrodes respectively disposed on the third and fourth surfaces, wherein the upper and lower cover portions each have a plurality of groove portions extending in the length direction of the body on the external surface in the thickness direction.

### Advantageous Effects of Invention

According to an aspect of the present disclosure, the reliability of a multilayer electronic component may be improved by having the upper and lower cover portions each include a plurality of groove portions of the body extending in the length direction on the external surface in the thickness direction.

According to an aspect of the present disclosure, the reliability of the multilayer electronic component having suppressed crack occurrence may be provided.

According to an aspect of the present disclosure, the multilayer electronic component having a structure capable of suppressing a shrinkage mismatch phenomenon between a cover portion and a capacitance formation portion during sintering may be provided.

However, the purpose of the present disclosure is not limited to the above-described content, and may be more easily understood in the process of explaining specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 is a perspective view illustrating FIG. 1 excluding an external electrode.

FIG. 3 schematically illustrates a cross-sectional view taken along line I-I’ of FIG. 1.

FIG. 4 schematically illustrates a cross-sectional view taken along line II-II’ of FIG. 1.

FIG. 5 schematically illustrates a cross-sectional view taken along line III-III' of FIG. 1.

FIG. 6 schematically illustrates a cross-sectional view taken along line IV-IV' of FIG. 1.

FIG. 7 is a drawing corresponding to FIG. 5 according to a first embodiment.

FIG. 8 is a drawing corresponding to FIG. 6 according to a second embodiment.

FIG. 9 is a drawing corresponding to FIG. 6 according to a third embodiment.

FIG. 10 is a drawing corresponding to FIG. 2 according to a fourth embodiment.

### DESCRIPTION OF REFERENCE CHARACTERS

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawing, an X-direction may be defined as a first direction, a stacking direction or a thickness T direction, a Y-direction may be defined as a second direction or a length L direction, and a Z-direction may be defined as a third direction or a width W direction.

### MULTILAYER ELECTRONIC COMPONENT

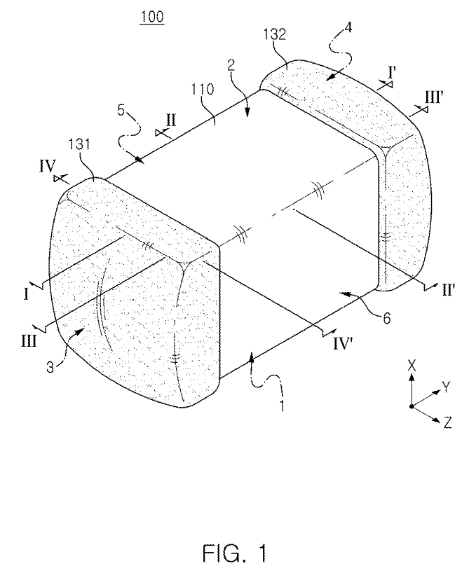

FIG. 1 schematically illustrates a perspective view of a multilayer electronic component according to an embodiment of the present disclosure.

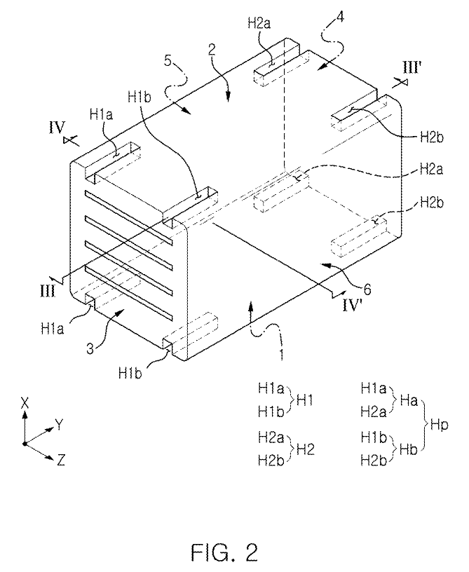

FIG. 2 is a perspective view illustrating FIG. 1 excluding an external electrode.

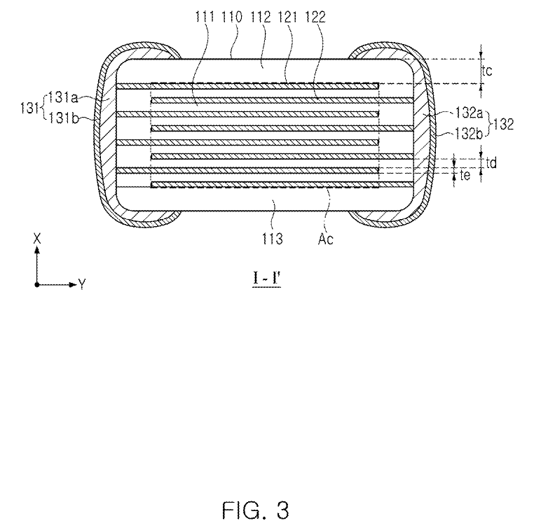

FIG. 3 schematically illustrates a cross-sectional view taken along line I-I’ of FIG. 1.

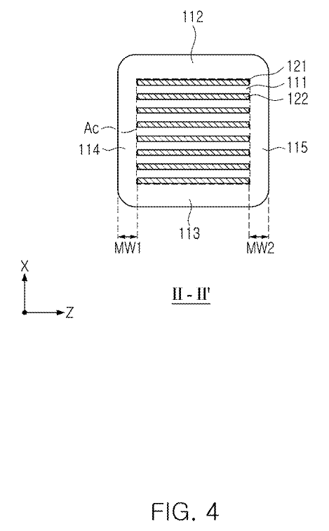

FIG. 4 schematically illustrates a cross-sectional view taken along line II-II’ of FIG. 1.

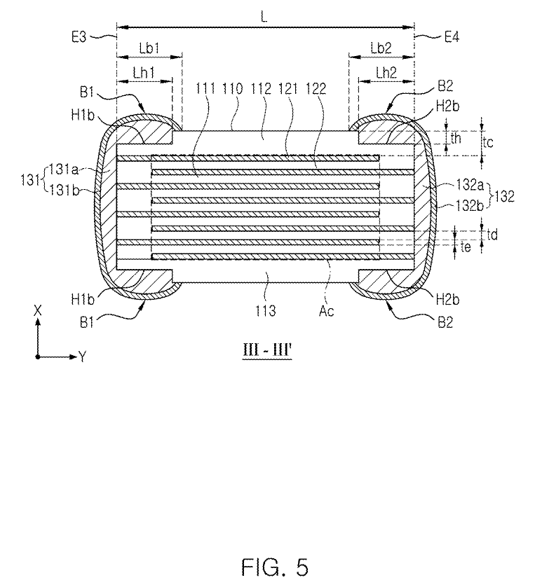

FIG. 5 schematically illustrates a cross-sectional view taken along line III-III' of FIG. 1.

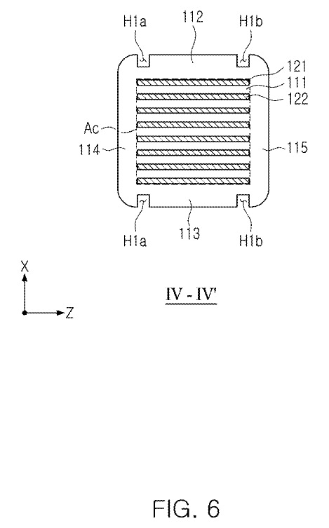

FIG. 6 schematically illustrates a cross-sectional view taken along line IV-IV' of FIG. 1.

Hereinafter, a multilayer electronic component 100 according to an embodiment of the present disclosure will be described in detail with reference to FIGS. 1-6. In addition, as an example of a multilayer electronic component, a multi-layered ceramic capacitor (hereinafter referred to as “MLCC”) is described, but the present disclosure is not limited thereto and may also be applied to various multilayer electronic components using ceramic materials, such as inductors, piezoelectric elements, varistors, or thermistors.

The multilayer electronic component 100 according to an embodiment of the present disclosure may comprise: a body 110 including a capacitance formation portion Ac comprising a dielectric layer 111 and first and second internal electrodes 121 and 122 alternately disposed in a thickness direction with the dielectric layer interposed therebetween, upper and lower cover portions 112 and 113 disposed on the upper portion and lower portion of the capacitance formation portion in the thickness direction, respectively, a first and second surfaces opposing each other in the thickness direction, third and fourth surfaces connected to the first and second surfaces and opposing each other in a length direction, and fifth and sixth surfaces connected to the first to fourth surfaces and opposing each other in a width direction, and a first and second first and second surfaces 1 and 2 opposing each other in the thickness direction, third and fourth surfaces 3 and 4 connected to the first and second surfaces and opposing each other in the length direction, and fifth and sixth surfaces 5 and 6 connected to the first to fourth surfaces and opposing each other in the width direction; and first and second external electrodes 131 and 132 disposed on the third and fourth surfaces respectively, wherein the upper and lower cover portions may each include a plurality of groove portions Hp extending the body in the length direction on an external surface in the thickness direction.

The body of the MLCC may include a capacitance formation portion having dielectric layers and internal electrodes alternately disposed, and a cover portion disposed on the upper and lower portions of the capacitance formation portion. During the sintering process, the cover portion, which only contains the dielectric, exhibits isotropic shrinkage behavior, but as the capacitance formation portion exhibits anisotropic shrinkage behavior, a shrinkage mismatching phenomenon may occur between the cover portion and the capacitance forming portion. Accordingly, there is a risk that cracks may occur in the body, reducing reliability.

On the other hand, according to an embodiment of the present disclosure, as the upper and lower cover portions 112 and 113 of the body 110 each include a plurality of groove portions Hp extending the body in the length direction on the external surface in the thickness direction, the shrinkage mismatching phenomenon may be alleviated, thereby improving the reliability of the multilayer electronic component 100.

Hereinafter, each component included in the multilayer electronic component 100 according to an embodiment of the present disclosure will be described.

The body 110 may have the dielectric layer 111 and the internal electrodes 121 and 122 alternately stacked therein.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may contract in a process in which the body is sintered, however, the body 110 may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As a margin region where the internal electrodes 121 and 122 are not disposed on the dielectric layer 111, overlaps, a step difference may occur due to the thickness of the internal electrodes 121 and 122, a corner connecting the first surface and the third to fifth surfaces and/or the corner connecting the second surface and the third to fifth surfaces may have a contracted form toward the center of the body 110 in the first direction when viewed based on the first surface or the second surface. Alternatively, due to the contraction behavior during a sintering process of the body, a corner connecting the first surface 1 and the third to sixth surfaces 3, 4, 5, and 6 and/or a corner connecting the second surface 2 and the third to sixth surfaces 3, 4, 5, and 6 may have a form contracting toward the center of the body 110 in the first direction when viewed based on the first surface or the second surface. Alternatively, to prevent chipping defects, or the like, the corners connecting each surface of the body 110 may be rounded by performing an additional process, in which the corners connecting the first surface and the third to sixth surfaces and/or the corners connecting the second surface and the third to sixth surfaces may have a round form.

A plurality of dielectric layers 111 forming the body 110 may be in a sintered state, and dielectric layers 111 may be integrated with each other, such that boundaries therebetween may not be readily apparent without a scanning electron microscope SEM. The number of dielectric layers is not particularly limited and it may be determined in consideration of a size of the multilayer electronic component. For example, a body may be formed by stacking more than 400 layers of dielectric layers.

The dielectric layer 111 may be formed by preparing a ceramic slurry containing ceramic powder, an organic solvent, and a binder, applying and drying the slurry on a carrier film to prepare a ceramic green sheet, and then sintering the ceramic green sheet. The ceramic powder is not particularly limited as long as sufficient electrostatic capacitance may be obtained, but for example, barium titanate (BaTiO₃)-based powder may be used as the ceramic powder. For a more specific example, the ceramic powder may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1).

An average thickness td of the dielectric layer 111 is not particularly limited, but may be, for example, the average thickness td of the dielectric layer 111 may be 0.1 μm to 10 μm. However, it is not limited thereto, and the average thickness td of the dielectric layer 111 may be arbitrarily set according to desired characteristics or purpose.

In this case, the average thickness td of the dielectric layer 111 may refer to a size of the dielectric layer 111 disposed between the internal electrodes 121 and 122 in the first direction. The average thickness of the dielectric layer 111 may be measured by scanning cross-sections of the body 110 in the first and second direction with a scanning electron microscope SEM of 10,000X magnification. More specifically, the thickness at a plurality of points of one dielectric layer 111, for example, at 30 points equally spaced apart from each other in the second direction, and then taking the average value. The 30 points which are equally spaced apart, may be designated in the capacitance formation portion Ac to be described later. In addition, when measuring the average value measurements is expanded to 10 dielectric layers 111 to calculate the average value, the average thickness of the dielectric layer 111 may be further generalized.

The body 110 may include a capacitance formation portion Ac including a dielectric layer 111 and first and second internal electrodes 121 and 122 disposed alternately in the thickness direction with the dielectric layer interposed therebetween, and upper and lower cover portions 112 and 113 disposed on upper and lower portions of the capacitance formation portion in the thickness direction, respectively.

The capacitance formation portion Ac may be disposed inside the body 110, and may form a capacitance by including a first internal electrode 121 and a second internal electrode 122 opposing each other with a dielectric layer 111 therebetween.

In addition, the capacitance formation portion Ac may be a portion contributing to a capacitance formation of the capacitor, and may be formed by repeatedly stacking a plurality of first and second internal electrodes 121 and 122 with a dielectric layer 111 therebetween.

The cover portions 112 and 113 may include an upper cover portion 112 disposed on an upper portion of the capacitance formation portion Ac in the thickness direction and a lower cover portion 113 disposed on a lower portion of the capacitance formation portion Ac in the thickness direction.

The upper and lower cover portions 112 and 113 may each include a plurality of groove portions Hp extending to the body in the length direction on the external surface in the thickness direction. Accordingly, the occurrences of cracks may be suppressed by suppressing the shrinkage mismatching phenomenon between the capacitance formation portion Ac and the cover portions 112 and 113 during the sintering process, thereby improving the reliability of the multilayer electronic component.

In the case when a plurality of groove portions Hp are disposed in only one of the upper and lower cover portions 112 and 113, a shrinkage mismatching phenomenon may occur between the cover portions where the groove portions Hp are not disposed and the capacitance formation portion Ac, and there is a risk that cracks may occur due to uneven tensile force distribution.

In an embodiment, a plurality of groove portions Hp may be disposed on two end portions of the body 110 in the width direction. When there is no groove portion in the cover portion as in the past, there is a high possibility cracking may occur due to the concentrated tensile force applied to both end portions of the cover portions in the width direction due to the shrinkage mismatch phenomenon between the cover portions and the capacitance formation portion during the sintering process. On the other hand, according to an embodiment of the present disclosure, when the groove portions Hp are disposed on both end portions of the cover portions in the width direction, the tensile force applied to both end portions of the cover portions may be more efficiently distributed, thereby further suppressing the occurrence of cracks.

The plurality of groove portions Hp may include a groove portion a Ha disposed on one end portion of the body in the width direction and a groove portion b Hb disposed on the other end portion of the body in the width direction. The groove portion a Ha may be disposed adjacent to the fifth surface, and the groove portion b Hb may be disposed adjacent to the sixth surface.

The groove portion a Ha and the groove portion b Hb may be spaced apart from the fifth and sixth surfaces, and the groove portion a Ha and the groove portion b Hb may be spaced apart from each other.

In this case, the end portions of the body 110 in the width direction may be a first and third regions when the body 110 is divided into three portions in the width direction.

In an embodiment, the plurality of groove portions Hp may include a first groove portion H1 extending from the third surface toward the fourth surface and a second groove portion H2 extending from the fourth surface toward the third surface. The first groove portion H1 may include a first groove portion a H1a and a first groove portion b H1b, and the second groove portion H2 may include a second groove portion a H2a and a second groove portion b H2b.

In an embodiment, when a length from the third surface to the fourth surface is L, a length from the third surface to an end of the first groove portion is Lh1, and a length from the fourth surface to an end of the second groove portion is Lh2, 0.1≤Lh1/L and 0.1≤Lh2/L may be satisfied. Accordingly, the tensile force distribution effect by the groove portions Hp may be further improved. More preferably, 0.13≤Lh1/L and 0.13≤Lh2/L may be satisfied, even more preferably 0.15≤Lh1/L and 0.15≤Lh2/L may be satisfied, and even more preferably 0.2≤Lh1/L and 0.2≤Lh2/L may be satisfied.

Referring to FIG. 5, L may refer to a length from an extension line E3 of the third surface to an extension line E4 of the fourth surface in the Y-direction, Lh1 may refer to a length from an extension line E3 of the third surface to an end of the first groove H1b in the Y-direction, and Lh2 may refer to a length from an extension line E4 of the fourth surface to an end of the second groove H2b in the Y-direction.

In an embodiment, a first external electrode 131 may include a first band portion B1 extending and disposed along the first and second surfaces, and a second external electrode 132 may include a second band portion B2 extending and disposed along the first and second surfaces, and when a length from the third surface to an end of the first groove portion is Lh1, a length from the third surface to an end of the first band portion is Lb1, a length from the fourth surface to an end of the second groove portion is Lh2, and a length from the fourth surface to an end of the second band portion is Lb2, Lh1≤Lb1 and Lh2≤Lb2 may be satisfied. In this case, the presence of a groove may not be observed on the external portion of the multilayer electronic component 100.

Referring to FIG. 5, Lb1 may refer to a length from an extension line E3 of the third surface to the end of the first band portion B1 in the Y-direction, and Lb2 may refer to a length from an extension line E4 of the fourth surface to the end of the second band portion B2 in the Y-direction.

In an embodiment, a depth th of the groove portion disposed in the upper cover portion 112 may be smaller than a thickness tc of the upper cover portion, and a depth of the groove portion disposed in the lower cover portion may be smaller than a thickness of the lower cover portion. When the depth th of the groove is greater than the thickness tc of the cover, there is a risk that the internal electrode may be exposed through the groove portion, and thus the moisture resistance reliability may be reduced.

In this case, the depth th of the groove portion disposed in the upper cover portion may be 1/3 or greater of the thickness tc of the upper cover portion, and the depth of the groove portion disposed in the lower cover portion may be 1/3 or greater of the thickness of the lower cover portion. Accordingly, the tensile force distribution effect by the groove portions Hp may be further improved.

Specific values for the depth th of the groove portions and the thickness tc of the cover portions are not particularly limited. For example, the depth th of the groove portions may be 10 to 250 μm, and the thickness tc of the cover portions 112 and 113 may be 20 to 300 μm.

The depth th of the groove and the thickness tc of the cover portions may refer to a thickness in the Z direction, and the depth th of the groove portions may be an average value measured at 5 points equally spaced apart in the Y-direction, and the thickness tc of the cover portions may be an average value measured at 5 points equally spaced apart in a region of the cover portions where no groove portions may be disposed.

Meanwhile, a method of forming the groove portions is not particularly limited. For example, the cover portions may be formed by stacking a single dielectric layer or two or more dielectric layers on the upper and lower surfaces of the capacitance formation portion Ac in the thickness direction, and then the groove portions Hp may be formed by pressing the cover portions with a pressing plate having a protrusion having a form corresponding to the groove portions Hp on the external surface of the cover portions, or the groove portions Hp may be formed by irradiating a laser.

The cover portions 112 and 113 may contribute to basically prevent damage to the internal electrodes due to physical or chemical stresses.

The cover portions 112 and 113 may not include the internal electrodes, and may include the same material as that of the dielectric layer 111.

That is, the cover portions 112 and 113 may include a ceramic material, for example, a barium titanate (BaTiO₃)-based ceramic material.

In addition, the margin portions 114 and 115 may be disposed on a side surface of the capacitance formation portion Ac.

The margin portions 114 and 115 may include a first margin portion 114 disposed on the fifth surface 5 of the body 110 and a second margin portion 115 disposed on the sixth surface 6 thereof. That is, the margin portions 114 and 115 may be disposed on both end surfaces of the body 110 in the width direction.

As illustrated in FIG. 3, the margin portions 114 and 115 may refer to a region between two ends of the first and second internal electrodes 121 and 122 and a boundary surface of the body 110 in a cross-section of the body 110 in a width-thickness (W-T) direction.

The margin portions 114 and 115 may basically contribute to prevent damage to the internal electrodes due to physical or chemical stresses.

The margin portions 114 and 115 may be formed by forming an internal electrodes by applying a conductive paste to the ceramic green sheet, except for a region where the margin portion is to be formed.

Meanwhile, a width of the margin portions 114 and 115 is not particularly limited. For example, an average width of the margin portions 114 and 115 may be 20 to 300 μm.

The average width of the margin portions 114 and 115 may refer to an average size MW1 of a region where the internal electrode is spaced apart from the fifth surface in the third direction and an average size MW2 of a region where the internal electrode is spaced apart from the sixth surface in the third direction, and may be an average value of a size of the margin portions 114 and 115 in the third direction measured at 5 points equally spaced apart on the side surface of the capacitance formation portion Ac.

Accordingly, in an embodiment, average sizes MW1 and MW2 of the regions spaced apart from the fifth and sixth surfaces of the internal electrodes 121 and 122 in the third direction, may be 20 to 300 μm, respectively.

The internal electrodes 121 and 122 may include a first and second internal electrodes 121 and 122. The first and second internal electrodes 121 and 122 may be alternately opposing each other with the dielectric layer 111 configuring the body 110 interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 of the body and connected to the first internal electrode 121, and a second external electrode 132 may be disposed on the fourth surface 4 of the body and connected to the second internal electrode 122.

That is, the first internal electrode 121 may be connected to the first external electrode 131, not connected to the second external electrode 132, and the second internal electrode 122 may be connected to the second external electrode 132, not connected to the first external electrode 131. Accordingly, the first internal electrode 121 may be formed spaced apart from a certain distance from the fourth surface 4, and the second internal electrode 122 may be formed spaced apart from a certain distance from the third surface 3. Additionally, the first and second internal electrodes 121 and 122 may be spaced apart from the fifth and sixth surfaces of the body 110.

The conductive metal included in the internal electrodes 121 and 122 may be one or more of Ni, Cu, Pd, Ag, Au, Pt, In, Sn, Al, Ti, and alloys thereof, but the present disclosure is not limited thereto.

A method for forming the internal electrodes 121 and 122 is not particularly limited. For example, the internal electrodes 121 and 122 may be formed by applying and sintering a conductive paste for internal electrodes containing conductive metal on the ceramic green sheet. An application method for the conductive paste for the internal electrodes may use a screen printing method or a gravure printing method, but the present disclosure is not limited thereto.

As another example, the internal electrodes 121 and 122 may be formed using a sputtering method, a vacuum deposition method, and/or a chemical vapor deposition method.

An average thickness te of the internal electrode does not need to be particularly limited. In this case, the thickness of the internal electrodes 121 and 122 may refer to a size of the internal electrodes 121 and 122 in the first direction. For example, the average thickness te of the internal electrodes 121 and 122 may be 0.1 to 2.0 μm.

In this case, the average thickness te of the internal electrodes may be measured by scanning the cross-sections of the body 110 in the first and second direction with a scanning electron microscope SEM of 10,000X magnification. More specifically, the average value may be measured by calculating the thickness at a plurality of points of one internal electrodes 121 and 122, for example, 30 points equally spaced apart from each other in the second direction, and then taking the average value. The 30 points which are equally spaced apart, may be designated in the capacitance formation portion Ac. Additionally, when measuring the average value measurement expanded to 10 internal electrodes 121 and 122, the average thickness of the internal electrodes 121 and 122 may be further generalized.

The external electrodes 131 and 132 may be disposed on the third and fourth surfaces. The external electrodes 131 and 132 may be disposed on the third and fourth surfaces 3 and 4 of the body 110, respectively, and may include first and second external electrodes 131 and 132 connected to the first and second internal electrodes 121 and 122, respectively. Additionally, the first and second external electrodes may be disposed to extend to portions of the first and second surfaces.

In addition, the external electrodes 131 and 132 may be disposed to cover both cross-sections of the margin portions 114 and 115 in the second direction.

Meanwhile, in the embodiment, a structure in which the multilayer electronic component 100 has two external electrodes 131 and 132 is described, but the number or shape of the external electrodes 131 and 132 may be changed depending on a shape of the internal electrodes 121 and 122 or other purposes.

The external electrodes 131 and 132 may include the first external electrode 131 and the second external electrode 132, wherein the first external electrode may include the first band portion B1 extending to a portion of the first and second surfaces, and the second external electrode may include the second band portion B2 extending to a portion of the first and second surfaces.

Meanwhile, the external electrodes 131 and 132 may be formed using any material having electrical conductivity, such as metal, and a specific material may be determined by considering electrical characteristics, structural stability, or the like, and further, may have a multilayer structure.

For example, the external electrodes 131 and 132 may include electrode layers 131a and 132a disposed on the body 110 and plating layers 131b and 132b formed on the electrode layers 131a and 132a.

For a more specific example of the electrode layers 131a and 132a, the electrode layers 131a and 132a may be firing electrodes including a conductive metal and a glass, or a resin-based electrode including a conductive metal and a resin. A material having excellent electrical conductivity may be used as the conductive metal included in the electrode layers 131a and 132a, but is not particularly limited thereto. For example, the conductive metal may be one or more of nickel (Ni), copper (Cu) and alloys thereof.

In an embodiment, the external electrodes 131 and 132 may be in contact with the internal electrodes 121 and 122 and may include the electrode layers 131a and 132a including Cu and glass and the plating layers 131b and 132b disposed on the electrode layer.

In addition, the electrode layers 131a and 132a may have a form in which the firing electrode and the resin-based electrode are sequentially formed on the body. In an embodiment, the electrode layers 131a and 132a may be in contact with the internal electrodes 121 and 122 and may include a base electrode layer comprising Cu and glass and a conductive resin layer disposed on the base electrode layer and containing a conductive metal and resin.

In addition, the electrode layers 131a and 132a may be formed by transferring a sheet including the conductive metal onto the body, or may be formed by transferring the sheet including the conductive metal to the fired electrode.

The plating layers 131b and 132b may contribute to improve mountability. A type of the plating layers 131b and 132b are not particularly limited, may be plating layers including one or more of Ni, Sn, Pd, and alloys thereof, and may be formed as a plurality of layers.

For a more specific example of the plating layers 131b and 132b, the plating layers 131b and 132b may be a Ni plating layer or a Sn plating layer, and may be formed in a structure in which a Ni plating layer and a Sn plating layer are sequentially formed on the electrode layers 131a and 132a, or may be in a structure in which a Sn plating layer, a Ni plating layer, and a Sn plating layer are sequentially formed.

A size of the multilayer electronic component 100 is not particularly limited.

However, as the size of the multilayer electronic component 100 increases, the tensile force applied to both end portions of the body in the width direction relatively increases, so in a multilayer electronic component 100 having a size of 3216 (length × width, 3.2 mm × 1.6 mm) or greater, the crack suppression effect due to the tensile force distribution effect by the groove portions Hp according to the present disclosure may be more significant.

Accordingly, when considering manufacturing tolerances, or the like, when the maximum length of the multilayer electronic component 100 is 3.0 mm or greater and the maximum width is 1.5 mm or greater, the crack suppression effect due to the tensile force distribution effect by the groove portions Hp according to the present disclosure may be more significant.

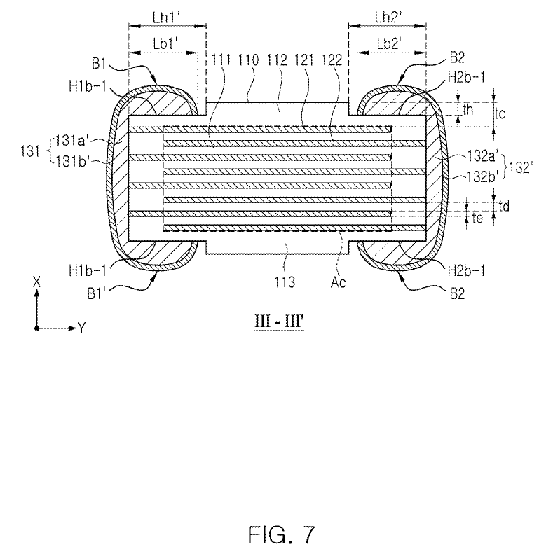

Hereinafter, the first to fourth embodiments of the present disclosure will be described with reference to FIGS. 7-10.

FIG. 7 is a drawing corresponding to FIG. 5 according to the first embodiment.

Referring to FIG. 7, a first external electrode 131` may include a first band portion B1’ extending and disposed along the first and second surfaces, and a second external electrode 132’ may include a second band portion B2’ extending and disposed along the first and second surfaces, and when a length from the third surface to an end of the first groove portion H1b-1 is Lh1’, a length from the third surface to an end of the first band portion is Lb1’, a length from the fourth surface to an end of the second groove portion H2b-1 is Lh2’, and a length from the fourth surface to an end of the second band portion is Lb2’, Lh1’>Lb1’ and Lh2’>Lb2’ may be satisfied.

According to the first embodiment, at least a portion of the groove portions of the first and second external electrodes 131’ and 132’ may not be covered, such that the presence of the groove portions may be observed from the external portion of the multilayer electronic component. Additionally, a portion of an end of the electrode layers 131a’ and 132a’ may be present within the groove portions, and a portion of an end of the plating layers 131b’ and 132b’ may be present within the groove portions.

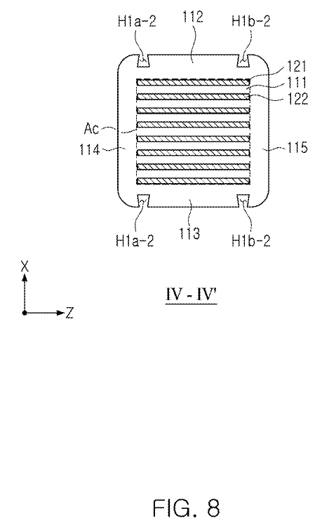

FIG. 8 is a drawing corresponding to FIG. 6 according to the second embodiment.

Referring to FIG. 8, a width of the groove portions H1a-2 and H1b-2 may become wider as it gets closer to the capacitance formation portion Ac. The form of these groove portions H1a-2 and H1b-2 may be formed when the shrinkage rate of the cover portions 112 and 113 during the sintering process is lower than the shrinkage rate of the capacitance formation portion Ac.

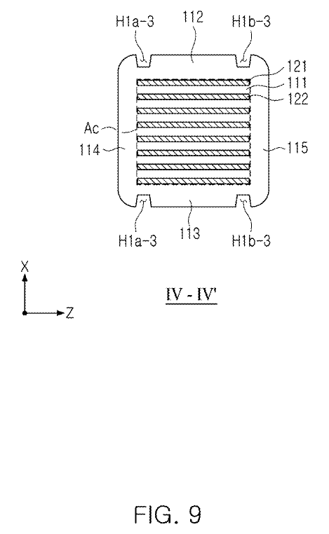

FIG. 9 is a drawing corresponding to FIG. 6 according to the third embodiment.

Referring to FIG. 9, a width of the groove portions H1a-3 and H1b-3 may become narrower as it gets closer to the capacitance formation portion Ac. The form of these groove portions H1a-3 and H1b-3 may be formed when the shrinkage rate of the cover portions 112 and 113 during the sintering process is higher than the shrinkage rate of the capacitance formation portion Ac.

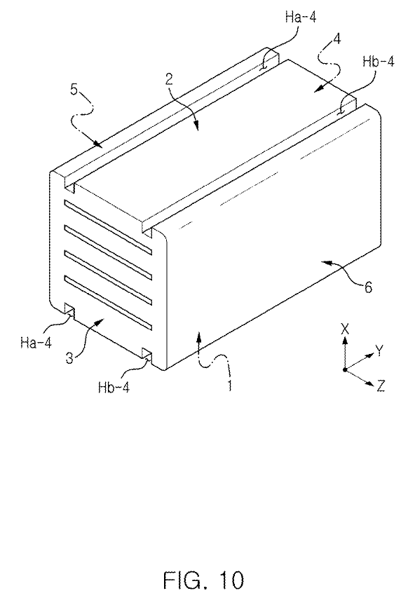

FIG. 10 is a drawing corresponding to FIG. 2 according to the fourth embodiment.

Referring to FIG. 10, groove portions Ha-4 and Hb-4 may be disposed to extend from the third surface to the fourth surface of the body 110. A groove portion a Ha-4 extending from the third surface to the fourth surface may be disposed on one end portion of the body in the width direction, and a groove b Ha-4 extending from the third surface to the fourth surface may be disposed on the other end portion of the body in the width direction.

Although the embodiments of the present disclosure have been described in detail above, the present disclosure is not limited by the above-described embodiments and the accompanying drawings, and is intended to be limited by the appended claims. Therefore, various forms of substitution, modifications, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a capacitance formation portion
comprising a dielectric layer and first and second internal electrodes alternately disposed in a thickness direction with the dielectric layer interposed therebetween, upper and lower cover portions disposed respectively on an upper portion and a lower portion of the capacitance formation portion in the thickness direction,
first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and
first and second external electrodes respectively disposed on the third and fourth surfaces,
wherein the upper and lower cover portions each have a plurality of groove portions extending in the length direction of the body on an external surface in the thickness direction.

2. The multilayer electronic component of claim 1, wherein the plurality of groove portions are disposed at both end portions of the body in the width direction.

3. The multilayer electronic component of claim 2, wherein the end portions of the body in the width direction are first and third regions when the body is divided into three parts in the width direction.

4. The multilayer electronic component of claim 1, wherein the plurality of groove portions include a first groove portion extending from the third surface toward the fourth surface and a second groove portion extending from the fourth surface toward the third surface.

5. The multilayer electronic component of claim 4, wherein a length from the third surface to the fourth surface is L, a length from the third surface to an end of the first groove portion is Lh1, and a length from the fourth surface to an end of the second groove portion is Lh2, and wherein
50.1≤Lh1/L and 0.1≤Lh2/L are satisfied.

6. The multilayer electronic component of claim 4,
wherein a first external electrode includes a first band portion extending and disposed on the first and second surfaces,
wherein a second external electrode includes a second band portion extending and disposed on the first and second surfaces,
wherein a length from the third surface to an end of the first groove portion is Lh1, a length from the third surface to an end of the first band portion is Lb1, a length from the fourth surface to an end of the second groove portion is Lh2, and a length from the fourth surface to an end of the second band portion is Lb2, and wherein
Lh1≤Lb1 and Lh2≤Lb2 are satisfied.

7. The multilayer electronic component of claim 4,
wherein the first external electrode includes a first band portion extending and disposed on the first and second surfaces,
wherein the second external electrode includes a second band portion extending and disposed on the first and second surfaces,
wherein a length from the third surface to an end of the first groove portion is Lh1’, a length from the third surface to an end of the first band portion is Lb1’, a length from the fourth surface to an end of the second groove portion is Lh2’, and a length from the fourth surface to an end of the second band portion is Lb2’, and wherein
Lh1’>Lb1’ and Lh2’>Lb2’ are satisfied.

8. The multilayer electronic component of claim 1,
wherein a width of the groove portion becomes wider as it gets closer to the capacitance formation portion.

9. The multilayer electronic component of claim 1,
wherein a width of the groove portion becomes narrower as it gets closer to the capacitance formation portion.

10. The multilayer electronic component of claim 1,
wherein the groove portion is disposed to extend from the third surface to the fourth surface.

11. The multilayer electronic component of claim 1,
wherein a depth of the groove portion disposed in the upper cover portion is smaller than a thickness of the upper cover portion, and a depth of the groove portion disposed in a lower cover portion is smaller than a thickness of the lower cover portion.

12. The multilayer electronic component of claim 1,
wherein a depth of the groove portion disposed in the upper cover portion is at least 1/3 of a thickness of the upper cover portion, and a depth of the groove portion disposed in the lower cover portion is at least 1/3 of a thickness of the lower cover portion.

13. The multilayer electronic component of claim 1,
wherein the multilayer electronic component has a maximum length of 3.0 mm or greater and a maximum width of 1.5 mm or
greater.
